(19) United States
(12) Patent Application Publication
(10) Pub. No.: US 2026/0140788 A1
(43) Pub. Date: May 21, 2026

(54) MICROSERVICE PREDICTION AND DISCOVERY FOR A MICROSERVICE WORKFLOW

(71) Applicant: SAP SE, Walldorf (DE)

(72) Inventors: Hui LI, Shanghai (CN); Zhen ZHANG, Shanghai (CN)

(21) Appl. No.: 18/955,520

(22) Filed: Nov. 21, 2024

(51) Int. Cl. G06F 9/54

(52) U.S. Cl. CPC G06F 9/54

(57) ABSTRACT

Disclosed herein are a system, method, and computer program product embodiments for predicting microservices that are likely to be called in a workflow and discovering uniform resource identifiers of such microservices. For example, a determination is made that a plurality of microservices of a microservice workflow are likely to be called. Responsive to determining that the plurality of microservices are likely to be called, a first microservice of the microservice workflow may obtain at least a first uniform resource identifier for a second microservice of the plurality of microservices and a second uniform resource identifier for a third microservice of the plurality of microservices. The first microservice may generate a call to a second microservice based on the first uniform resource identifier, wherein the call comprises the second uniform resource identifier for the third microservice.

### BACKGROUND

Microservices are processes that communicate with each other over a network, each tending to be independently developed and deployed, and each providing respective capabilities to the microservices network that are relatively confined in scope. The use of microservices has been trending upwards and is being adopted by many large scale distributed systems.

Each microservice in the microservices network registers itself with a register center or database using its uniform resource identifier (URI) (e.g., a network address). This way, other microservices can locate the address of a particular microservice for communication therewith. Before one microservice calls another microservice, the microservice queries the register center to obtain the URI of the other microservice.

However, too many calls to the register center will bring high pressure to the register center and cause a lengthy time delay when returning URIs to requesting microservices. One option to reduce the calls to the register center is to cache all of the register center data in the local memory of every microservice. However, this disadvantageously consumes valuable memory resources of the microservices and stores unneeded URIs that one service may never use to call another service. Moreover, each microservice would have to periodically call the register center to sync the register data between the register center and its local memory.

### BRIEF DESCRIPTION OF THE DRAWINGS

The accompanying drawings are incorporated herein and form a part of the specification.

FIG. 1 shows a block diagram of a system configured to predict microservices that are likely to be called in one or more workflows and discover uniform resource identifiers of such microservices, according to some embodiments.

FIG. 2 is a call flow diagram illustrating example communications between a database and different microservices, according to some embodiments.

FIG. 3 is a flowchart of a method for predicting microservices that are likely to be called in a workflow and discovering uniform resource identifiers of such microservices, according to some embodiments.

FIG. 4 is a flowchart of a method for determining that a plurality of microservices of a microservice workflow are likely to be called, according to some embodiments.

FIG. 5 is a flowchart of a method for determining a number of calls between each microservice of the plurality of microservices in the microservice workflow, according to some embodiments.

FIG. 6 is a flowchart of a method for executing a workflow via a cloud computing system that comprises a gateway, according to some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are a system, apparatus, device, method and/or computer program product embodiments, and/or combinations and sub-combinations thereof, for predicting microservices that are likely to be called in one or more workflows and discovering uniform resource identifiers of such microservices. For example, a determination is made that a plurality of microservices of a microservice workflow are likely to be called. Responsive to determining that the plurality of microservices are likely to be called, a first microservice of the microservice workflow may obtain at least a first uniform resource identifier for a second microservice of the plurality of microservices and a second uniform resource identifier for a third microservice of the plurality of microservices. The first microservice may generate a call to a second microservice based on the first uniform resource identifier, wherein the call comprises the second uniform resource identifier for the third microservice.

The techniques described herein improve the functioning of a computing system. For example, conventional techniques require each microservice of a microservice workflow to query a register center or database for URIs for every other microservices in the workflow. Not only does this increase network bandwidth, but it also overburdens the register center or database with queries, which causes delays when returning URIs to requesting microservices. The embodiments described herein, however, drastically limit the number of calls to the register center or database. Instead of each microservice of the workflow querying the register center or database, just a select number of microservices of the workflow query the register center or database. By limiting the number of queries in such a manner, the network bandwidth between the microservices and the register center or database is reduced, along with the computing resources (e.g., processor cycles, memory, storage, etc.) of the microservices and register center or database.

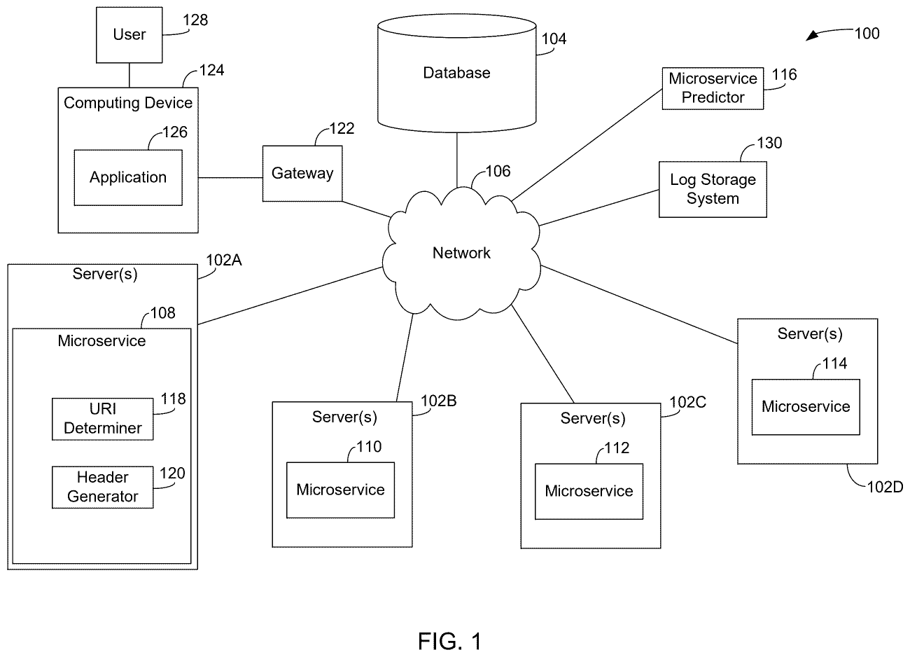

FIG. 1 shows a block diagram of a system 100 configured to predict microservices that are likely to be called in one or more workflows and discover uniform resource identifiers of such microservices, according to some embodiments. As shown in FIG. 1, system 100 includes one or more servers 102A-102D, a database 104 (also referred to as a register center), a microservice predictor 116, a gateway 122, a computing device 124, and a log storage system 130. Server(s) 102A-102D, gateway 122, microservice predictor 116, log storage system 130, and/or database 104 may be communicatively coupled to each other via a network 106. Network 106 may comprise one or more networks such as local area networks (LANs), wide area networks (WANs), enterprise networks, the Internet, etc., and may include one or more of wired and/or wireless portions.

In an embodiment, server(s) 102A-102D may form a network-accessible server set (e.g., a cloud-based environment or platform). Server(s) 102A-102D may be accessible via network 106 (e.g., in a “cloud-based” embodiment) to build, deploy, and manage applications, services, and/or microservices. Server(s) 102A-102D may be co-located (e.g., housed in one or more nearby buildings with associated components such as backup power supplies, redundant data communications, environmental controls, etc.) to form a datacenter, or may be arranged in other manners. Accordingly, in an embodiment, server(s) 102A-102D may be a datacenter in a distributed collection of datacenters.

Each of server(s) 102A-102D may be configured to execute one or more software applications (or “applications”), services and/or microservices. Microservices are small, independently-versioned and scalable, modular services (e.g., computer programs/applications) that communicate with each other over standard protocols (e.g., Hypertext Transfer Protocol (HTTP), Simple Object Access Protocol (SOAP), a Remote Procedure Call (RPC)-based protocol, etc.) with well-defined interfaces (e.g., application programming interfaces (APIs)). Each microservice may implement a set of focused and distinct features or functions. Microservices may be written in any programming language and may use any framework.

As shown in FIG. 1, server(s) 102A may be configured to execute a first microservice 108, server(s) 102B may be configured to execute a second microservice 110, server(s) 102C may be configured to execute a third microservice 112, and server(s) 102D may be configured to execute a fourth microservice 114. Database 104 may be configured to store one or more uniform resource identifiers (URIs) for each of a plurality of different microservices (e.g., microservices 108, 110, 112, and 114). The uniform resource identifier(s) comprise one or more uniform resource locators (URL(s)) and/or one or more port numbers. In some embodiments, database 104 may store one or more unique URIs and/or associated port numbers for a given microservice. Each of the unique URI(s) may indicate a network address of a respective server that hosts a particular microservice. The URI and/or port number to be utilized to access a given microservice may be determined based on a load balancing algorithm, which balances/distributes the traffic across the servers (e.g., server(s) 102A-102D) that host the microservices (e.g., microservices 102A-102D). Database 104 may be any type of database, including a relational database (RDB), a non-relational database (e.g., a NoSQL database), or a distributed registration platform.

Each of microservices 108, 110, 112, and 114 may be configured to register itself with database 104. During the registration process, each of microservices 108, 110, 112, and 114 may provide its respective URIs to database 104, and database 104 may store such URIs in association with the microservice. Each of microservices 108, 110, 112, and 114 may periodically update its URIs with database 104.

Microservices 108, 110, 112, and 114 may collaboratively perform an ordered set of processes to perform one or more tasks. Such a series of activities may be referred to as a microservice workflow. As an example, an employee (e.g., user 128) of a company (or tenant) may request a particular record or activity (e.g., generate a purchase order). For example, user 128 may initiate an initial request from an application (e.g., application 126) executing on computing device 124. The initial request may be provided to gateway 122. This initial request from user 128 will cause one or more microservices to execute a series of tasks. Gateway 122 may provide the request to the first microservice to be executed in the workflow (e.g., microservice 108). After completion of the workflow, a response (e.g., comprising the newly generated purchase order) may be returned to gateway 122, which provides the response to employee 128 via application 126. In one example, the execution of certain microservices may be triggered by other microservices. In another example, certain microservices may rely on data generated and/or obtained from other microservices. Accordingly, one microservice may call another microservice to perform a particular task. The microservice may call the other microservice using the URI(s) of the other microservice. Computing device 124 may be any type of stationary device, such as a desktop computer or PC (personal computer), or mobile computing device (such as a laptop computer, a notebook computer, a tablet computer, etc.).

A microservice may obtain the URI(s) of another microservice utilizing database 104. For instance, the microservice may send a query via a remote call to database 104 that identifies the other microservice. In response, database 104 may obtain (e.g., lookup) the URI(s) associated with the identified microservice and provide a response indicating the URI(s) to the requesting microservice.

As described above, an excess number of remote calls to database 104 may overburden database 104, and thus, result in a delay in obtaining URI(s) for a requesting microservice. The embodiments described herein advantageously limit or reduce the number of calls to database 104. For instance, instead of each microservice in a given workflow having to query database 104 for URI(s), a subset of microservice(s) (e.g., a single microservice) may obtain the URI(s) for a plurality of other microservices that are predicted to be called during the workflow. The subset of microservice(s) may provide the URI(s) to the other microservices in the workflow so that the other microservices do not have to query database 104 for such URIs. This way, the number of remote calls to database are reduced.

For instance, as shown in FIG. 1, microservice 108 may be the first microservice that executes in a microservice workflow as called by gateway 122. For instance, user 128, having made an initial request that is routed to microservice 108 via gateway 122, will receive a response from microservice 108 via gateway 122. As an example, if user 128 requests a purchase order (either a single purchase order or a large group of them as part of a batch process), microservice 108 may make subsequent requests to microservices 110 and 112 (either in parallel or in series where microservice 110 makes the subsequent request to microservice 112).

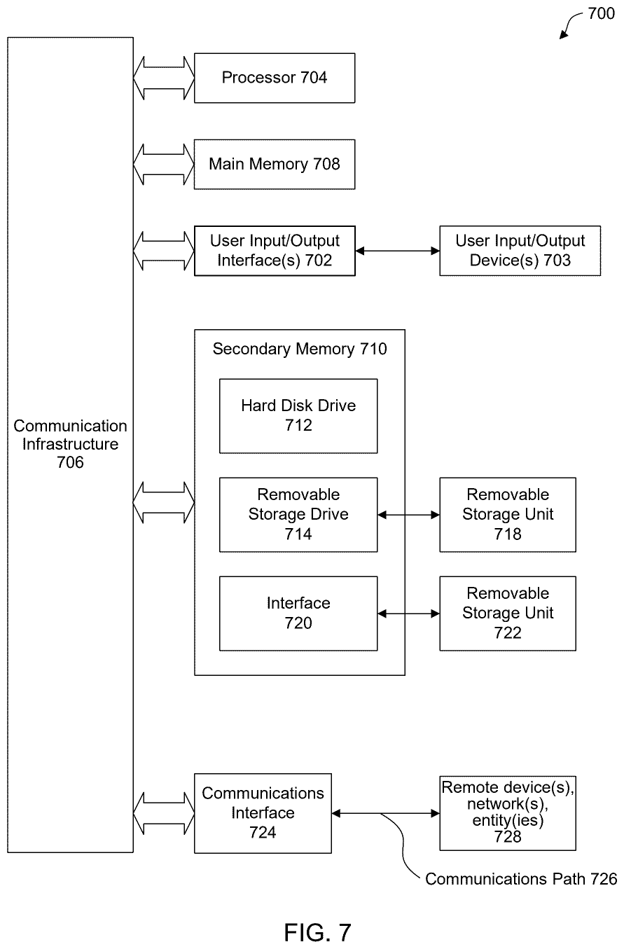

Microservice predictor 116 may be implemented by processing logic that can comprise hardware (e.g., circuitry, dedicated logic, programmable logic, microcode, etc.), software (e.g., instructions executing on a processing device), or a combination thereof. In an embodiment, microservice predictor 116 is implemented in one or more software processes executing on one or more processor-based computer systems, such as computer system 700 as described below in reference to FIG. 7.

Microservice predictor 116 may be configured to predict which microservices (e.g., microservices 108, 110, 112, and 114) are to be called in the workflow. For example, microservice predictor 116 may obtain logs for past executions of the workflow from log storage system 130, where each microservice of a particular workflow returns a log indicating one or more other microservices it called during execution of the workflow to log storage system 130. The logs may be obtained by microservice predictor 116 periodically (e.g., daily, weekly, etc.). Each log may indicate how many times a given microservice was called by another microservice during a given execution of the workflow. For each pair of microservices in the workflow, microservice predictor 116 may count the number of times a first microservice in the pair called a second microservice in the pair.

Microservice predictor 116 may generate a data structure that stores the number of calls between each pair of microservices in the workflow. In some embodiments, the data structure is an invocation matrix. For instance, suppose there are an N number of available microservices (s₁, s₂, . . . , s_{N}) in a given system, where N is any positive integer. The invocation matrix may be structured as follows:

$$R = [ \begin{matrix}{r}_{1 , 1} & {r}_{1 , 2} & {r}_{1 , 3} & {r}_{1 , 4} & ... & {r}_{1 , N} \\ {r}_{2 , 1} & {r}_{2 , 2} & {r}_{2 , 3} & {r}_{2 , 4} & ... & {r}_{2 , N} \\ {r}_{3 , 1} & {r}_{3 , 2} & {r}_{3 , 3} & {r}_{3 , 4} & ... & {r}_{3 , N} \\ {r}_{4 , 1} & {r}_{4 , 2} & {r}_{4 , 3} & {r}_{4 , 4} & ... & {r}_{4 , N} \\ ... & ... & ... & ... & ... & ... \\ {r}_{N , 1} & {r}_{N , 2} & {r}_{N , 3} & {r}_{N , 4} & ... & {r}_{N , N}\end{matrix} ]$$

where R corresponds to the invocation matrix, where r_{i,j} corresponds to the number of remote calls from service sᵢ to service sⱼ during a predetermined time period of a given workflow, and where i and j are any two positive integers. It is noted that when i and j are the same integer values, r_{i,j} represents the count that the service s is the last service of the workflow (i.e., the service s does not call any other service during the predetermined time period). It should be noted that each microservice predictor 116 will generate a plurality of R invocation matrices for a plurality of workflows it processes. In some embodiments there will be one R invocation matrix for every workflow processed.

Based on the invocation matrix R, microservice predictor 116 may determine the probability that one microservice of a microservice pair directly calls another microservice of the microservice pair. In some embodiments, the probability that a microservice sᵢ calls microservice sⱼ is determined in accordance with Equation 1, which is provided below:

$${c}_{i , j} = \{ \begin{matrix}\frac{{r}_{i , j}}{{\sum }_{k = 1}^{N} {r}_{i , k}} , & if i \neq j and {\sum }_{k = 1}^{N} {r}_{i , k} \neq 0 \\ 0 , & if i = j or {\sum }_{k = 1}^{N} {r}_{i , k} = 0\end{matrix} \qquad ( Equation 1 )$$

where c_{i,j} corresponds to the probability that microservice sᵢ calls microservice sⱼ. In accordance with Equation 1, the probability may be determined by dividing the number of remote calls made from microservice sᵢ to microservice sⱼ (represented by r_{i,j}) divided by the total number of remote calls made by microservice sᵢ to all microservices (represented by

$${\sum }_{k = 1}^{N} {r}_{i , k} ) .$$

Microservice predictor 116 may generate a data structure that stores the determined probability for each pair of microservices in the workflow. In some embodiments, the data structure is a correlation matrix. The correlation matrix may be structured as follows:

$$C = [ \begin{matrix}0 & {c}_{1 , 2} & {c}_{1 , 3} & {c}_{1 , 4} & ... & {c}_{1 , N} \\ {c}_{2 , 1} & 0 & {c}_{2 , 3} & {c}_{2 , 4} & ... & {c}_{2 , N} \\ {c}_{3 , 1} & {c}_{3 , 2} & 0 & {c}_{3 , 4} & ... & {c}_{3 , N} \\ {c}_{4 , 1} & {c}_{4 , 2} & {c}_{4 , 3} & 0 & ... & {c}_{4 , N} \\ ... & ... & ... & ... & ... & ... \\ {c}_{N , 1} & {c}_{N , 2} & {c}_{N , 3} & {c}_{N , 4} & ... & 0\end{matrix} ]$$

where C corresponds to the correlation matrix, where c_{i,j} corresponds to the probability that microservice sᵢ calls microservice sⱼ during the workflow.

The microservice invocation relationship may be modeled as a Markov process, which is a stochastic process describing a sequence of possible events in which the probability of each event depends on just the state attained in the previous event. That is, the microservice that is called in the future depends on just the present microservice and not on microservices called prior to the present microservice. When modeling the microservice invocation relationship as a Markov process, the probability that a remote call from microservice sᵢ eventually results to a call to microservice sⱼ via an intermediary microservice may be determined (e.g., microservice sᵢ calls microservice s_{z}, which calls microservice sⱼ). The determined probabilities may be determined utilizing a two-step correlation matrix, as shown below:

$${C}^{( 2 )} = C \times C = [ \begin{matrix}{c}_{1 , 1}^{( 2 )} & {c}_{1 , 2}^{( 2 )} & {c}_{1 , 3}^{( 2 )} & {c}_{1 , 4}^{( 2 )} & ... & {c}_{1 , N}^{( 2 )} \\ {c}_{2 , 1}^{( 2 )} & {c}_{2 , 2}^{( 2 )} & {c}_{2 , 3}^{( 2 )} & {c}_{2 , 4}^{( 2 )} & ... & {c}_{2 , N}^{( 2 )} \\ {c}_{3 , 1}^{( 2 )} & {c}_{3 , 2}^{( 2 )} & {c}_{3 , 3}^{( 2 )} & {c}_{3 , 4}^{( 2 )} & ... & {c}_{3 , N}^{( 2 )} \\ {c}_{4 , 1}^{( 2 )} & {c}_{4 , 2}^{( 2 )} & {c}_{4 , 3}^{( 2 )} & {c}_{4 , 4}^{( 2 )} & ... & {c}_{4 , N}^{( 2 )} \\ ... & ... & ... & ... & ... & ... \\ {c}_{N , 1}^{( 2 )} & {c}_{N , 2}^{( 2 )} & {c}_{N , 3}^{( 2 )} & {c}_{N , 4}^{( 2 )} & ... & {c}_{N , N}^{( 2 )}\end{matrix} ]$$

where

$${c}_{i , j}^{( 2 )}$$

corresponds to the probability that a remote call from microservice sᵢ results in a call to microservice sⱼ via two steps (e.g., microservice sᵢ calls microservice s_{z}, which calls microservice sⱼ).

It is noted that while the embodiments described above determine a probability that a remote call from one microservice results in a call to another microservice via two steps, the probability for any number (m) of steps may be determined, for example, utilizing an m-step correlation matrix, as shown below:

$${C}^{( m )} = C \times C \times ... \times C = [ \begin{matrix}{c}_{1 , 1}^{( m )} & {c}_{1 , 2}^{( m )} & {c}_{1 , 3}^{( m )} & {c}_{1 , 4}^{( m )} & ... & {c}_{1 , N}^{( m )} \\ {c}_{2 , 1}^{( m )} & {c}_{2 , 2}^{( m )} & {c}_{2 , 3}^{( m )} & {c}_{2 , 4}^{( m )} & ... & {c}_{2 , N}^{( m )} \\ {c}_{3 , 1}^{( m )} & {c}_{3 , 2}^{( m )} & {c}_{3 , 3}^{( m )} & {c}_{3 , 4}^{( m )} & ... & {c}_{3 , N}^{( m )} \\ {c}_{4 , 1}^{( m )} & {c}_{4 , 2}^{( m )} & {c}_{4 , 3}^{( m )} & {c}_{4 , 4}^{( m )} & ... & {c}_{4 , N}^{( m )} \\ ... & ... & ... & ... & ... & ... \\ {c}_{N , 1}^{( m )} & {c}_{N , 2}^{( m )} & {c}_{N , 3}^{( m )} & {c}_{N , 4}^{( m )} & ... & {c}_{N , N}^{( m )}\end{matrix} ] , \\ ( Mutiply m times )$$

where

$${c}_{i , j}^{( m )}$$

corresponds to the probability that a remote call from microservice sᵢ results in a call to microservice sⱼ via m steps (e.g., microservice sᵢ calls microservice s_{y}, which calls microservice s_{z}, which calls microservice sⱼ), where m corresponds to any positive integer. In some embodiments, the maximum value of m (denoted as M) may be configurable.

Each of the probabilities

$${c}_{i , j}^{( m )}$$

may be compared to a threshold value THₘ (where 1≤m≤M). If a probability meets or exceeds the threshold value, then microservice predictor 116 determines that it is likely that microservice i calls microservice j during the workflow. Microservice predictor 116 may generate an indication indicating as such. For example, the indication may be an indicator set to a first value, e.g., 1. If the probability does not meet or exceed the threshold value, then microservice predictor 116 determines that it is not likely that microservice i calls microservice j during the workflow. Microservice predictor 116 may generate an indication indicating as such. For example, the indication may be an indicator set to a second value, e.g., 0.

Microservice predictor 116 may generate a data structure that stores such indications for each pair of microservices. In some embodiments, the data structure is a transfer matrix. The transfer matrix may be structured as follows:

$$T = [ \begin{matrix}0 & {t}_{1 , 2} & {t}_{1 , 3} & {t}_{1 , 4} & ... & {t}_{1 , N} \\ {t}_{2 , 1} & 0 & {t}_{2 , 3} & {t}_{2 , 4} & ... & {t}_{2 , N} \\ {t}_{3 , 1} & {t}_{3 , 2} & 0 & {t}_{3 , 4} & ... & {t}_{3 , N} \\ {t}_{4 , 1} & {t}_{4 , 2} & {t}_{4 , 3} & 0 & ... & {t}_{4 , N} \\ ... & ... & ... & ... & ... & ... \\ {t}_{N , 1} & {t}_{N , 2} & {t}_{N , 3} & {t}_{N , 4} & ... & 0\end{matrix} ]$$

where T corresponds to the transfer matrix, where t_{i,j} corresponds to the indication that it is likely that microservice i calls microservice j, where i and j are any two different positive integers (i.e., i and j are not the same integer values).

In some embodiments, the indication that a microservice sᵢ is likely to call microservice sⱼ is determined in accordance with Equation 2, which is provided below:

$${t}_{i , j} = \{ \begin{matrix}1 , & if i \neq j and ( {c}_{i , j} > {TH}_{1} or {c}_{i , j}^{( 2 )} > \\ & {TH}_{2} or ... or {c}_{i , j}^{( M )} > {TH}_{M} ) \\ 0 , & other\end{matrix} \qquad ( Equation 2 )$$

where the confidence value c for a given microservice pair is compared to a respective threshold m (THₘ). Each threshold may be a value between 0 and 1. In some embodiments, each of the thresholds are configurable.

Microservice 108 may comprise a URI determiner 118 and a header generator 120. Each of URI determiner 118 and header generator 120 may be implemented by processing logic that can comprise hardware (e.g., circuitry, dedicated logic, programmable logic, microcode, etc.), software (e.g., instructions executing on a processing device), or a combination thereof. In an embodiment, each of URI determiner 118 and header generator 120 is implemented in one or more software processes executing on one or more processor-based computer systems, such as computer system 700 as described below in reference to FIG. 7. It is noted that each of microservices 110, 112, and 114 may also include a respective instance of URI determiner 118, and header generator 120. However, they are not shown for the sake of brevity. It is further noted that in some embodiments, microservice predictor 116 may be included in one or more of microservices 108, 110, 112, and 114.

URI determiner 118 may be configured to periodically obtain and analyze transfer matrix T and determine which microservices (e.g., microservices 110, 112, and 114) are likely to be called during a workflow. For example, URI determiner 118 may check each element of transfer matrix T (e.g., elements t_{i,x}, where 1≤x≤N). If any element t_{i,x} is equal to 1, then URI determiner 118 may add microservice x to a list of associated microservices. For example, if transfer matrix T indicates that microservice 2 calls microservice 3 (i.e., t_{2,3} equals 1), then URI determiner 118 adds microservice 3 to the list of associated microservices. Similarly, if transfer matrix T indicates that microservice 1 calls microservice 3 through intermediary microservice 2 (i.e., t_{1,3} equals 1), then URI determiner 118 adds microservice 3 to the list of associated microservices (if not already added).

URI determiner 118 may discover the URIs for each of the microservices in the list of associated microservices. For example, URI determiner 118 may provide a remote call to database 104 that queries database 104 for the URIs for each of the microservices in the list of associated microservices. The remote call may include an identifier for each microservice in the list. Database 104 determines the URIs for each of the identified microservices and provides a response to URI determiner 118 that includes the URIs for each of the identified microservices.

Header generator 120 may be configured to generate a header for a remote call (e.g., a request) to the next microservice in the workflow. The header may include the URIs for each of the identified microservices as key-value pairs. In some embodiments, the header is a custom HTTP header (e.g., named ASSOCIATED_SERVICE_ADDRESS). Table 1 depicts a header for specifying URIs for different microservices in accordance with an example embodiment:

TABLE 1

| Header Key | Header Values | Example of Header Values |
|---|---|---|
| ASSOCIATED_{—} | The key-value | s3 = 10.1.1.12:8080, |
| SERVICE_{—} | pairs of | 10.1.1.9:8080; |
| ADDRESS | associated | s4 = 10.4.1.13:8080, |
| | services | 10.1.15.7:8080; |
| | | s5 = 10.81.1.5:8080, |
| | | 10.92.1.8:8080; |
| | | s6 = 10.16.1.1:8080, |
| | | 10.24.1.6:8080; |

In accordance with Table 1, each of microservices s3, s4, s5, and s6 were included in the list of associated microservices. As shown in Table 1, two URIs are specified for each of microservices s3, s4, s5, and s6. It is noted that the URIs provided above are purely exemplary and that other URIs may be utilized, and that any number of URIs may be specified for a given microservice.

After header generator 120 generates the header, microservice 108 may generate a request including the header and provide the request to the next microservice in the workflow (e.g., microservice 110). Microservice 110 may determine the next microservice that is to be called (e.g., microservice 112) and determines whether the URI for microservice 112 is included in the header received from microservice 108. If the URI for microservice 112 is included in the header, then microservice 110 generates a request to microservice 112 based on the URI of microservice 112 included in the header. The request may include some or all of the same header information that was provided via the request transmitted by microservice 108. For instance, microservice 110 may copy the header from the request transmitted by microservice 108 into the header of the request provided to microservice 112. However, in other implementations the header data could be edited by removing the URI information of the next inline transmitting microservice (e.g., microservice 110 could remove its own URI(s) from the header before inserting the modified header into the call to microservice 112). If the URI for microservice 112 is not included in the header, microservice 110 may determine a list of associated services in a similar fashion as described above with reference to URI determiner 118 and query database 104 for the URI of microservice 112, as well as the URIs in the list of associated services. Microservice 110 may generate a header including such URIs in a similar fashion as described above with reference to header generator 120 and include the header in the remote call to microservice 112. The foregoing process may be performed by each microservice in the workflow responsive to receiving a request (or remote call) from another microservice.

In some embodiments, microservice 108 may cache the URIs for each of the identified microservices. This way, microservice 108 does not need to regenerate the matrices described above in the event that microservice 108 initiates execution of workflow that it has already executed (or a similar workflow).

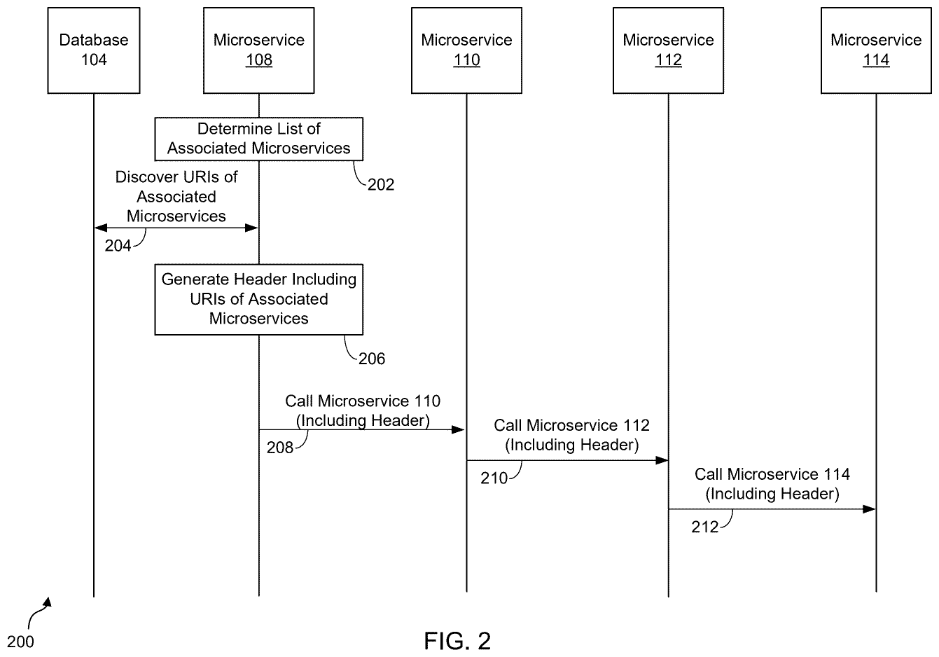

FIG. 2 is a call flow diagram 200 illustrating example communications between database 104 and microservices 108, 110, 112, and 114 for a workflow, according to some embodiments. Microservice 108 may be the first microservice that performs an operation for the workflow. As shown in FIG. 2, at 202, microservice 108 may determine a list of associated microservices based on an analysis of a transfer matrix T, as described above with reference to FIG. 1. The list of associated microservices indicates microservices that are likely to be called in the workflow. In the example shown in FIG. 2, microservice 108 may determine that microservices 110, 112, and/or 114 are likely to be called.

At 204, microservice 108 may discover URIs associated with each of the associated microservices, as described above with reference to FIG. 1. For example, microservice 108 may query database 104 for URIs of microservices 110, 112, and/or 114.

At 206, microservice 108 may generate a header including the URIs obtained from database 104, as described above with reference to FIG. 1.

At 208, microservice 108 may generate a call to the next microservice in the workflow (e.g., microservice 110). The call includes the header generated at 206.

At 210, microservice 110 analyzes the header to determine the URI of the next microservice to be called in the workflow (e.g., microservice 112), and generates a call to microservice 112 utilizing the URI for microservice 112 from the header. The call may include the header or a modified header generated at 206.

At 212, microservice 112 analyzes the header of the call provided at 210 to determine the URI of the next microservice to be called in the workflow (e.g., microservice 114), and generates a call to microservice 114 utilizing the URI for microservice 112 from the header. The call to microservice 114 may include the header or a modified header generated at 206.

Accordingly, as demonstrated in FIG. 2, just a single remote call to database 104 (e.g., at 204) was made to obtain the URIs of the microservices of the workflow. Contrast this with conventional techniques, where each of microservice 108, 110, 112, and 114 would provide a remote call to database 104 for the URI of the next microservice in the workflow. It should be noted that FIG. 2 shows the calling of microservices in a workflow. As noted above, a response or responses (e.g., a purchase order, a list of sales data, personnel records, etc.) are provided in response to the microservice calls but are omitted for from FIG. 2 for clarity and brevity.

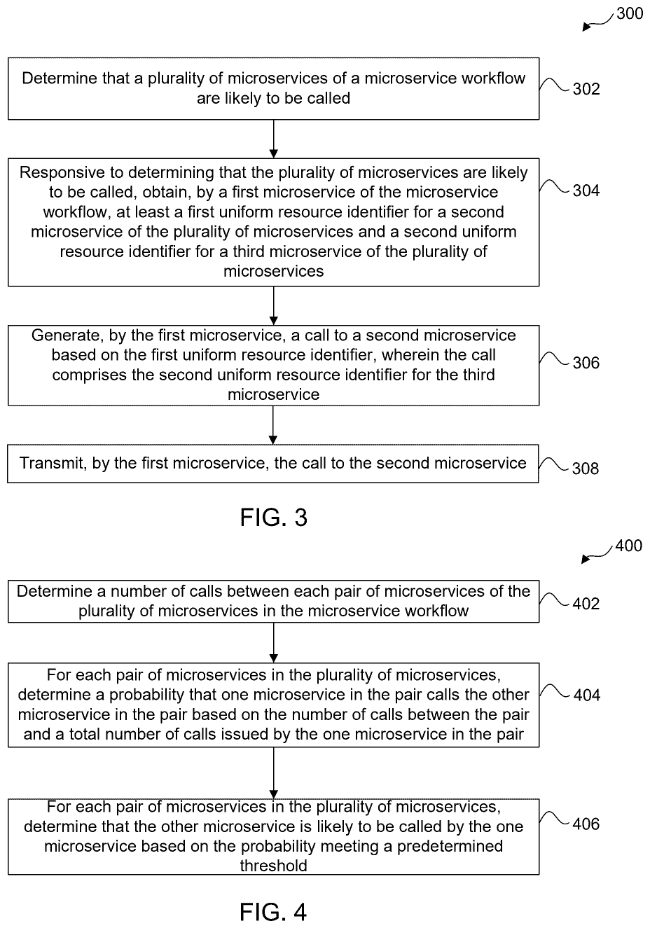

FIG. 3 is a flowchart of a method 300 for predicting microservices that are likely to be called in a workflow and discovering uniform resource identifiers of such microservices, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 1. However, method 300 is not limited to that example embodiment.

At 302, a determination is made that a plurality of microservices of a microservice workflow are likely to be called. For example, referring to FIG. 1, URI determiner 118 may determine that a plurality of microservices of a microservice workflow are likely to be called (e.g., based on an analysis of a transfer matrix). Additional details regarding the determination of the microservices that are likely to be called are provided below with reference to FIG. 4.

At 304, responsive to determining that the plurality of microservices are likely to be called, a first microservice of the microservice workflow may obtain at least a first uniform resource identifier for a second microservice of the plurality of microservices and a second uniform resource identifier for a third microservice of the plurality of microservices. For example, referring to FIG. 1, the first microservice of the microservice workflow may be microservice 108. In such an example, URI determiner 118 of microservice 108 may, responsive to determining that the plurality of microservices are likely to be called, may obtain at least a first URI for a second microservice (e.g., microservice 110) of the plurality of microservices and a second URI for a third microservice (e.g., microservice 112) of the plurality of microservices.

In some embodiments, URI determiner 118 may obtain at least the first URI and the second URI by obtaining at least the first URI and the second URI from database 104 that maintains URIs for the plurality of microservices. For instance, URI determiner 118 may query database 104 for at least the first URI and the second URI. URI determiner 118 may provide an indication of the second and third microservices in the query. Database 104 may obtain at least the first URI and the second URI based on the indication of the second and third microservices.

In some embodiments, the first URI comprises at least one URL associated with the second microservice, and the second URI comprises at least one URL associated with the third microservice. For instance, each of the first and second URIs may comprise a plurality of URLs.

At 306, the first microservice may generate a call to a second microservice based on the first URI, wherein the call comprises the second URI for the third microservice. For example, referring to FIG. 1, microservice 108 may generate a call to microservice 110 based on the first URI. The call may comprise the second URI for the third microservice (e.g., microservice 112). In some embodiments, the second URI is included in a header of the call. For example, referring to FIG. 1, header generator 120 may generate a header for the call. The header includes the second URI for the third microservice (e.g., microservice 112).

At 308, the first microservice may transmit the call to the second microservice. For example, referring to FIG. 1, microservice 108 may transmit the call to microservice 110. FIG. 4 is a flowchart of a method 400 for determining that a plurality of microservices of a microservice workflow are likely to be called, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIG. 1. However, method 400 is not limited to that example embodiment.

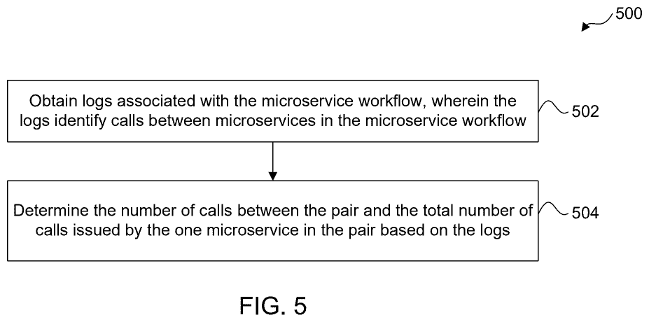

At 402, microservice predictor 116 may determine a number of calls between each pair of microservices of the plurality of microservices in the microservice workflow. Additional details regarding the determination of the number of calls between pairs of microservices are provided below with reference to FIG. 5.

At 404, for each pair of microservices in the plurality of microservices, microservice predictor 116 may determine a probability that one microservice in the pair calls the other microservice in the pair based on the number of calls between the pair and a total number of calls issued by the one microservice in the pair. For example, as described above, microservice predictor 116 may analyze the invocation matrix R and determine the probability that one microservice in the pair calls the other microservice in the pair in accordance with Equation 1.

At 406, for each pair of microservices in the plurality of microservices, microservice predictor 116 may determine that the other microservice is likely to be called by the one microservice based on the probability meeting a predetermined threshold. For instance, as described above, microservice predictor 116 may determine that the other microservice is likely to be called by the one microservice by comparing the probability to a predetermined threshold in accordance with Equation 2.

FIG. 5 is a flowchart of a method 500 for determining a number of calls between each microservice of the plurality of microservices in the microservice workflow, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIG. 1. However, method 500 is not limited to that example embodiment.

At 502, microservice predictor 116 may obtain logs associated with the microservice workflow, wherein the logs identify calls between microservices in the microservice workflow. The logs may be stored in log storage system 130. The logs may be generated during past executions of the workflow. Each log may indicate how many times a given microservice was called by another microservice during a given execution of the workflow.

At 504, microservice predictor 116 may determine the number of calls between the pair and the total number of calls issued by the one microservice in the pair based on the logs. For example microservice predictor 116 may count the number of times a first microservice in the pair called a second microservice in the pair.

In some embodiments, a gateway (e.g., gateway 122) may initiate the execution of a workflow based on an initial request received from a user. For example, with reference to FIG. 1, the initial request could be to generate a purchase order. Upon receiving the first call, microservice 108 calls another microservice 110 to obtain pricing information for the product being ordered. Microservice 110 may determine if the product is still on the pricing list (i.e., available for purchase) and issue another call to yet a different microservice (e.g., microservice 112) to obtain availability information of a warehouse and an expected shipping date. Other microservices (e.g., microservice 114) could also be called. The aforementioned information may be returned to a particular microservice (e.g., the first microservice, such as microservice 108) in the workflow, which may assemble the pieces of information received from the other microservices to generate a complete purchase order. The particular microservice may transmit the complete purchase order back to gateway 122 for forwarding to the seller of the product.

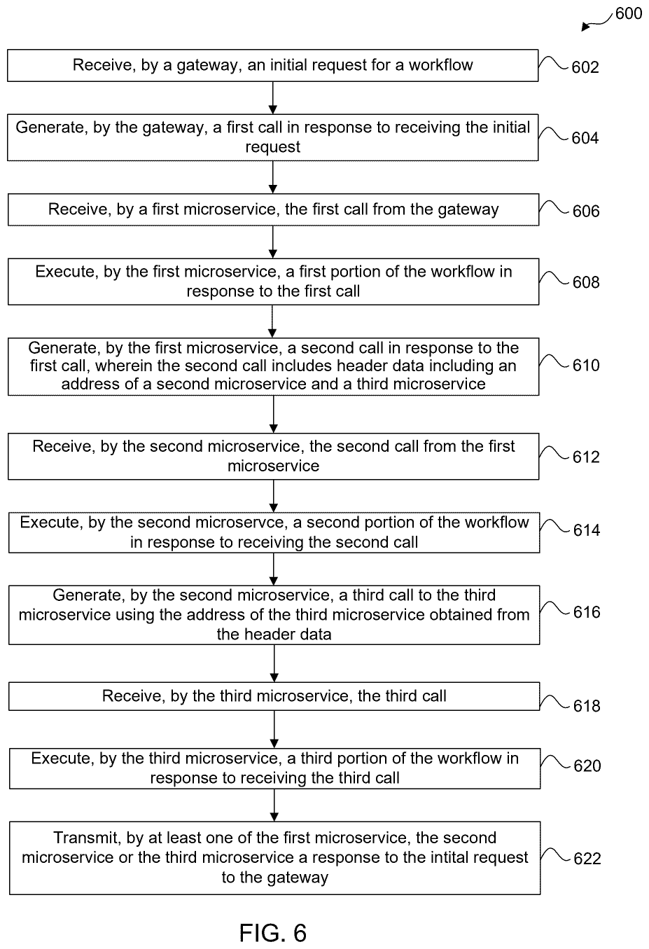

FIG. 6 is a flowchart of a method 600 for executing a workflow via a cloud computing system that comprises a gateway, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIG. 1. However, method 600 is not limited to that example embodiment.

At 602, gateway 122 may receive an initial request for a workflow, for example, from user 128 via application 126.

At 604, gateway 122 may generate a first call in response to receiving the initial request.

At 606, a first microservice (e.g., microservice 108) may receive the first call from gateway 122.

At 608, the first microservice may execute a first portion of the workflow in response to the first call.

At 610, the first microservice may generate a second call in response to the first call, wherein the second call includes header data including an address of a second microservice (e.g., microservice 110) and an address of a third microservice. In some embodiments, the addresses comprise URLs of the second and third microservice. In alternative implementations the address of the second microservice may be omitted from this portion of the header data.

At 612, the second microservice (e.g., microservice 110) may receive the second call from the first microservice.

At 614, the second microservice may execute a second portion of the workflow in response to receiving the second call.

At 616, the second microservice may generate a third call to the third microservice (e.g., microservice 112) using the address of the third microservice obtained from the header data.

At 618, the third microservice may receive the third call.

At 620, the third microservice may execute a third portion of the workflow in response to receiving the third call.

At 622, at least one of the first microservice, the second microservice, or the third microservice may be transmit a response to the initial request to gateway 122.

In some embodiments, the first microservice is configured to determine a plurality of microservices (e.g., microservices 110, 112, and/or 114) that are likely to be called.

In some embodiments, the first microservice is configured to determine the plurality of microservices that are likely to be called in similar manner as described above with reference to FIG. 4. For example, the first microservice may determine a number of calls between each pair of microservices of the plurality of microservices, and for each pair of microservices in the plurality of microservices, determine a probability that one microservice in the pair calls the other microservice in the pair based on the number of calls between the pair and a total number of calls issued by the one microservice in the pair, and determine that the other microservice is likely to be called by the one microservice based on the probability meeting a predetermined threshold.

In some embodiments, the first microservice may determine the number of calls between each microservice of the plurality of microservices in a similar manner as described above with reference to FIG. 5. For example, the first microservice may obtain logs associated with the workflow, wherein the logs identify calls between microservices in the workflow and determine the number of calls between the pair and the total number of calls issued by the one microservice in the pair based on the logs.

In some embodiments, the first microservice is further configured to obtain the address of the second microservice and store the address in the header data of the second call. In some embodiments, the first microservice may obtain the address of the second microservice by obtaining the address from a database that maintains addresses for the plurality of microservices.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
determining that a plurality of microservices of a microservice workflow are likely to be called;
responsive to determining that the plurality of microservices are likely to be called, obtaining, by a first microservice of the microservice workflow, at least a first uniform resource identifier for a second microservice of the plurality of microservices and a second uniform resource identifier for a third microservice of the plurality of microservices; and
generating, by the first microservice, a call to a second microservice based on the first uniform resource identifier, wherein the call comprises the second uniform resource identifier for the third microservice; and
transmitting the call to the second microservice.

2. The method of claim 1, wherein determining that the plurality of microservices are likely to be called comprises:
determining a number of calls between each pair of microservices of the plurality of microservices in the microservice workflow;
for each pair of microservices in the plurality of microservices:
determining a probability that one microservice in the pair calls the other microservice in the pair based on the number of calls between the pair and a total number of calls issued by the one microservice in the pair; and
determining that the other microservice is likely to be called by the one microservice based on the probability meeting a predetermined threshold.

3. The method of claim 2, wherein determining the number of calls between each microservice of the plurality of microservices in the microservice workflow comprises:
obtaining logs associated with the microservice workflow, wherein the logs identify calls between microservices in the microservice workflow; and
determining the number of calls between the pair and the total number of calls issued by the one microservice in the pair based on the logs.

4. The method of claim 1, wherein the second uniform resource identifier is included in a header of the call.

5. The method of claim 1, wherein obtaining at least the first uniform resource identifier and the second uniform resource identifier comprises obtaining at least the first uniform resource identifier and the second uniform resource identifier from a database that maintains uniform resource identifiers for the plurality of microservices.

6. The method of claim 1, wherein the first uniform resource identifier comprises at least one uniform resource locator associated with the second microservice, and wherein the second uniform resource identifier comprises at least one uniform resource locator associated with the third microservice.

7. The method of claim 1, wherein determining that the plurality of microservices are likely to be called comprises determining, by the first microservice, that the plurality of microservices are likely to be called.

8. A system, comprising:
a memory; and
at least one processor coupled to the memory and configured to:
determine that a plurality of microservices of a microservice workflow are likely to be called;
responsive to a determination that the plurality of microservices are likely to be called, obtain, by a first microservice of the microservice workflow, at least a first uniform resource identifier for a second microservice of the plurality of microservices and a second uniform resource identifier for a third microservice of the plurality of microservices;
generate, by the first microservice, a call to a second microservice based on the first uniform resource identifier, wherein the call comprises the second uniform resource identifier for the third microservice; and
transmit, by the first microservice, the call to the second microservice.

9. The system of claim 8, wherein, to determine that the plurality of microservices are likely to be called, the at least one processor is configured to:
determine a number of calls between each pair of microservices of the plurality of microservices in the microservice workflow;
for each pair of microservices in the plurality of microservices:
determine a probability that one microservice in the pair calls the other microservice in the pair based on the number of calls between the pair and a total number of calls issued by the one microservice in the pair; and
determine that the other microservice is likely to be called by the one microservice based on the probability meeting a predetermined threshold.

10. The system of claim 9, wherein, to determine the number of calls between each microservice of the plurality of microservices in the microservice workflow, the at least one processor is configured to:
obtain logs associated with the microservice workflow, wherein the logs identify calls between microservices in the microservice workflow; and
determine the number of calls between the pair and the total number of calls issued by the one microservice in the pair based on the logs.

11. The system of claim 8, wherein the second uniform resource identifier is included in a header of the call.

12. The system of claim 8, wherein, to obtain at least the first uniform resource identifier and the second uniform resource identifier, the at least one processor is configured to obtain at least the first uniform resource identifier and the second uniform resource identifier from a database that maintains uniform resource identifiers for the plurality of microservices.

13. The system of claim 8, wherein the first uniform resource identifier comprises at least one uniform resource locator associated with the second microservice, and wherein the second uniform resource identifier comprises at least one uniform resource locator associated with the third microservice.

14. A cloud computing system comprising:
a gateway configured to receive an initial request for a workflow and generate a first call in response to receiving the initial request; and
a plurality of microservices, wherein a first microservice of the plurality of microservices is configured to:
receive the first call from the gateway and execute a first portion of the workflow in response to the first call;
generate a second call in response to the first call, wherein the second call includes header data including an address of a second microservice and an address of a third microservice of the plurality of microservices, wherein a second microservice of the plurality of microservices is configured to;
receive the second call from the first microservice;
execute a second portion of the workflow in response to receiving the second call;
generate a third call to the third microservice using the address of the second microservice obtained from the header data, wherein the third microservice is configured to:
receive the third call; and
executes a third portion of the workflow in response to receiving the third call, and wherein at least one of the first microservice, the second microservice or the third microservice is further configured to transmit a response to the initial request to the gateway.

15. The cloud computing system of claim 14, wherein the first microservice is further configured to:
determine that the plurality of microservices are likely to be called.

16. The cloud computing system of claim 15, wherein, to determine that the plurality of microservices are likely to be called, the first microservice is configured to:
determine a number of calls between each pair of microservices of the plurality of microservices; and
for each pair of microservices in the plurality of microservices:
determine a probability that one microservice in the pair calls the other microservice in the pair based on the number of calls between the pair and a total number of calls issued by the one microservice in the pair; and
determine that the other microservice is likely to be called by the one microservice based on the probability meeting a predetermined threshold.

17. The cloud computing system of claim 16, wherein, to determine the number of calls between each microservice of the plurality of microservices, the first microservice is configured to:
obtain logs associated with the workflow, wherein the logs identify calls between microservices in the workflow; and
determine the number of calls between the pair and the total number of calls issued by the one microservice in the pair based on the logs.

18. The cloud computing system of claim 14, wherein the first microservice is further configured to obtain the address of the second microservice and store the address in the header data of the second call.

19. The cloud computing system of claim 18, wherein, to obtain the address of the second microservice, the first microservice is configured to obtain the address from a database that maintains addresses for the plurality of microservices.

20. The cloud computing system of claim 14, wherein the address of the second microservice comprises a uniform resource locator of the second microservice, and wherein the address of the third microservice comprises a uniform resource locator of the third microservice.
